(19) United States
(12) Patent Application Publication
(10) Pub. No.: US 2025/0200435 A1
(43) Pub. Date: Jun. 19, 2025

(54) SECURE GLOBAL MODEL CALCULATION APPARATUS, LOCAL MODEL REGISTERING METHOD, AND PROGRAM

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/849,655

(22) PCT Filed: Mar. 31, 2022
(86) PCT No.: PCT/JP2022/016501

§ 371 Date: Sep. 23, 2024

(51) Int. Cl. G06N 20/00

(52) U.S. Cl. CPC G06N 20/00

(57) ABSTRACT

Provided is a technique for efficiently receiving a local model required for computation of a global model in federated learning. A secure global model computation device in a federated learning system including M local model learning devices for learning local models using training data and a secure global model computation system composed of N secure global model computation devices for performing secure computation of a global model from M local models includes a processing vacancy checking unit configured to check whether or not the N secure global model computation devices have processing vacancy when a processing vacancy check request transmitted by one of the M local model learning devices is received and to transmit a local model transmission instruction to the local model learning device and enter a reception waiting state when all of the N secure global model computation devices have processing vacancy.

### TECHNICAL FIELD

The present invention relates to a federated learning technique, and particularly, to a technique for efficiently receiving a local model required to compute a global model.

### BACKGROUND ART

As a technique for learning training data without aggregating the training data into one device, there is a federated learning technique. As a federated learning technique, for example, there is FedAVG described in Non Patent Literature 1.

FIG. 1 is a diagram showing a basic configuration of a federated learning system. The federated learning system 90 includes M (M is an integer of 2 or more) local model learning devices 100₁, . . . , 100_{M} and a global model computation device 900. The basic operation of the federated learning system 90 is as follows. The local model learning devices 100₁, . . . 100_{M} learn local models using training data recorded in their own recording units. After completion of learning, the local model learning devices 100₁, . . . , 100_{M} transmit the local models to the global model computation device 900 via a network 800. The global model computation device 900 computes a global model using the received local models. After completion of computation, the global model computation device 900 transmits the global model to the local model learning devices 100₁, . . . , 100_{M} via the network 800. The local model learning devices 100₁, . . . , 100_{M} re-learn the local models using the received global model. By repeating this operation, the federated learning system 90 advances model learning. In this case, the global model computation device 900 manages parameters of the local models by using a local model management table.

When the federated learning technique is used, since training data is not taken out to the outside of a local model learning device, anxiety about taking the data out can be eliminated, and at the same time, high speed can be attained through parallel learning. However, if parameters of a model under learning are traced and leaked from the process of communication between the local model learning devices 100₁, . . . , 100_{M} and the global model computation device 900, for example, there is a risk of training data being estimated. In order to avoid such a risk, using secure computation for computation of a global model can be considered.

Secure computation is a method of obtaining results of a designated arithmetic operation without restoring encrypted numerical values (refer to Reference Non Patent Literature 1, for example). In the method of Reference Non Patent Literature 1, encryption for distributing a plurality of pieces of information that can be used to restore numerical values to three secure computation devices can be performed to maintain a state in which results of addition/subtraction, constant sum, multiplication, constant multiplication, logical operations (negation, logical product, logical sum, and exclusive logical sum), data format conversion (integer, binary) have been distributed to the three secure computation devices without restoring numerical values, that is, in an encrypted state. In general, the number of distributions is not limited to 3 and can be N (N is an integer of 3 or more), and a protocol for realizing secure computation according to cooperative computation by N secure computation devices is called a multiparty protocol.
(Reference Non Patent Literature 1: Koji Chida, Koki Hamada, Dai Igarashi, and Katsumi Takahashi, “Reconsideration of Lightweight Verifiable 3-Party Secure Function Computation,” In CSS, 2010.)

### CITATION LIST

### Non Patent Literature

[NPL 1] McMahan, B., E. Moore, D. Ramage, et al., “Communication-efficient learning of deep networks from decentralized data,” In Artificial Intelligence and Statistics, pp. 1273-1282, 2017.

### SUMMARY OF INVENTION

### Technical Problem

However, as a result of variation in the timing of completion of learning due to differences in the amount of training data used by a local model learning device for learning and the computing capability of the local model learning device, the timing of receiving a local model by a secure computation system that computes a global model also varies, deteriorating the processing efficiency of the secure computation system. Further, in some cases, deadlock may occur in the secure computation system.

Accordingly, an object of the present invention is to provide a technique for efficiently receiving a local model required to compute a global model in federated learning.

### Solution to Problem

One aspect of the present invention is a secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device including: a processing vacancy checking unit configured to check whether or not the N secure global model computation devices have processing vacancy when a processing vacancy check request transmitted by one of the M local model learning devices is received and to transmit a local model transmission instruction to the local model learning device and enter a reception waiting state when all of the N secure global model computation devices have processing vacancy; a transmission/reception unit configured to receive shares of parameters of a local model learned by the local model learning device; and a parameter share registration unit configured to register the shares of the parameters of the local model.

One aspect of the present invention is a secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device including: a processing vacancy checking unit configured to check whether or not N-1 secure global model computation devices excluding the secure global model computation device itself have processing vacancy at any time and to disclose the fact that the N secure global model computation devices are in a local model reception waiting state when all of the N secure global model computation devices have processing vacancy; a transmission/reception unit configured to receive shares of parameters of a local model learned by one of the M local model learning devices; and a parameter share registration unit configured to register the shares of the parameters of the local model.

One aspect of the present invention is a secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device including: wherein a secure global model computation device different from the secure global model computation device itself, which discloses the fact the N secure global model computation devices are in a local model reception waiting state when all of the N secure global model computation devices have processing vacancy, is set as a master secure global model computation device, a processing vacancy checking unit configured to reply whether the secure global model computation device itself has processing vacancy to check presence or absence of processing vacancy at any time from the master secure global model computation device; a transmission/reception unit configured to receive shares of parameters of a local model learned by one of the M local model learning devices; and a parameter share registration unit configured to register the shares of the parameters of the local model.

### Advantageous Effects of Invention

According to the present invention, it is possible to efficiently receive a local model required to compute a global model in federated learning.

### BRIEF DESCRIPTION OF DRAWINGS

FIG. 1 is a diagram showing a basic configuration of a federated learning system 90.

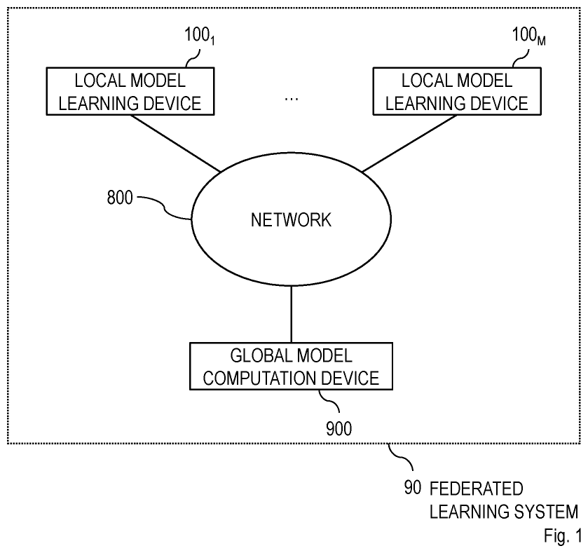

FIG. 2 is a block diagram showing a configuration of a federated learning system 10.

FIG. 3 is a block diagram showing a configuration of a local model learning device 100ₘ.

FIG. 4 is a block diagram showing a configuration of a secure global model computation device 200ₙ.

FIG. 5 is a flowchart showing an operation of the local model learning device 100ₘ.

FIG. 6 is a flowchart showing an operation of a secure global model computation system 20.

FIG. 7 is a diagram showing an example of a functional configuration of a computer which realizes each device in embodiments of the present invention.

### DESCRIPTION OF EMBODIMENTS

The following describes embodiments of the present invention in detail. Note that constituent elements having the same function will be denoted by the same reference numerals and redundant description thereof will be omitted.

A notation method used in this specification will be described before the embodiments are described.

\hat{ } (caret) denotes a superscript. For example, x^{y\hat{ }z} means that y^{z} is a superscript to x and x_{y\hat{ }z} means that y^{z} is a subscript to x. In addition, _ (underscore) denotes subscript. For example, x^{y_z} means that y_{z} is a superscript to x and x_{y_z} means that y_{z} is a subscript to x.

Superscripts “\hat{ }” and “˜” as in \hat{ }x and ˜x for a certain character x would normally be written directly above “x,” but are written as \hat{ }x or ˜x here due to restrictions on notation in this specification.

### TECHNICAL BACKGROUND

### Secure Computation

Secure computation in the present invention is constructed using a combination of arithmetic operations in existing secure computation. Arithmetic operations necessary for the secure computation include, for example, concealment, addition, subtraction, multiplication, division, logical operations (negation, logical product, logical sum, and exclusive logical sum), and comparison operations (=, <, >, ≤, and ≥). Several arithmetic operations and their notation will be described below.

### Concealment

[[x]] is assumed to be a value obtained by concealing x by secret sharing (hereinafter referred to as a share of x). Any method can be used as a secret sharing method. For example, Shamir secure sharing on GF (2⁶¹-1) and replicated secret sharing on z₂ can be used.

A plurality of secret sharing methods may be used in combination in one algorithm. In this case, it is assumed that they are converted to each other as appropriate.

Further, it is assumed that [[^{→}x]]=([[x₁]], . . . , [[x_{N}]]) for an N-dimensional vector ^{→}x=(x₁, . . . , x_{N}). That is, [[^{→}x]] is a vector having a share [[xₙ]] of an n-th element xₙ of ^{→}x as an n-th element. Similarly, for an M×N matrix A=(a_{m,n})(1≤m≤M, 1≤n≤N), [[A]] is assumed to be a matrix having a share [[a_{m, n}]] of an (m, n)-th element of A as an (m, n)-th element.

Note that x is referred to as a plaintext of [[x]].

As a method of obtaining [[x]] from x (concealment) and a method of obtaining x from [[x]] (restoration), specifically, there are methods described in Reference Non Patent Literature 1 and Reference Non Patent Literature 2.

(Reference Non Patent Literature 2: Shamir, A., “How to share a secret,” Communications of the ACM, Vol. 22, No. 11, pp. 612-613, 1979.)

[Addition, subtraction, multiplication, and division] Addition [[x]]+[[y]] according to secure computation has [[x]] and [[y]] as inputs and [[x+y]] as an output. Subtraction [[x]]−[[y]] according to secure computation has [[x]] and [[y]] as inputs and [[x−y]] as an output. Multiplication [[x]]×[[y]] (which may be represented as mul ([[x]], [[y]]) according to secure computation has [[x]] and [[y]] as inputs and [[x×y]] as an output. Division [[x]]/[[y]] (which may be represented as div([ [x]], [[y]]) according to secure computation has [[x]] and [[y]] as inputs [[x/y]] as an output.

As specific methods of addition, subtraction, multiplication and division, there are methods described in Reference Non Patent Literature 3 and Reference Non Patent Literature 4.

(Reference Non Patent Literature 3: Ben-Or, M., Goldwasser, S. and Wigderson, A., “Completeness theorems for non-cryptographic fault-tolerant distributed computation,” Proceedings of the twentieth annual ACM symposium on Theory of computing, ACM, pp. 1-10, 1988.)

(Reference Non Patent Literature 4: Gennaro, R., Rabin, M. O. and Rabin, T., “Simplied VSS and fast-track multiparty computations with applications to threshold cryptography,” Proceedings of the seventeenth annual ACM symposium on Principles of distributed computing, ACM, pp. 101-111, 1998.)

### Logical Operations

Negation not [[x]] according to secure computation has [[x]] as an input and [[not (x)]] as an output. Logical product and ([[x]], [[y]]) according to secure computation has [[x]] and [[y]] as inputs and [[and (x, y)]] as an output. Logical sum or ([[x]], [[y]]) according to secure computation has [[x]] and [[y]] as inputs and [[or (x, y)]] as an output. Exclusive logical sum xor ([[x]], [[y]]) according to secure computation has [[x]] and [[y]] as inputs and [[xor(x, y)]] as an output.

Note that logical operations can be easily constructed by combining addition, subtraction, multiplication, and division.

### Comparison Operations

Equal sign decision=([[x]], [[y]]) (which may be represented as equal ([[x]], [[y]]) according to secure computation has [[x]] and [[y]] as inputs, [[1]] as an output when x=y, and [[0]] as an output in other cases. Comparison <([[x]], [[y]]) according to secure computation has [[x]] and [[y]] as inputs, [[1]] as an output when x<y, and has [[0]] as an output in other cases. Comparison>([[x]], [[y]]) according to secure computation has [[x]] and [[y]] as inputs, [[1]] as an output when x>y, and [[0]] as an output in other cases. Comparison ≤([[x]], [[y]]) according to secure computation has [[x]] and [[y]] as inputs, [[1]] as an output when x≤y, and [[0]] as an output in other cases. Comparison≥([[x]], [[y]]) according to secure computation has [[x]] and [[y]] as inputs, [[1]] as an output when x≥y, and [[0]] as an output in other cases.

Note that comparison operations can be easily constituted by combining logical operations.

### First Embodiment

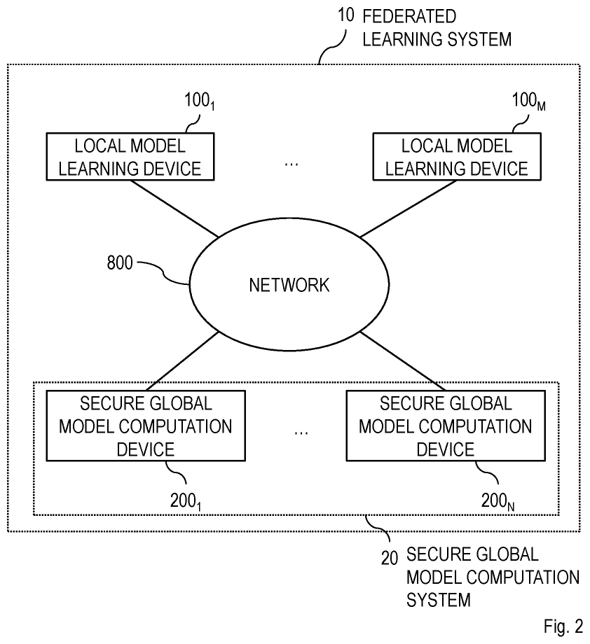

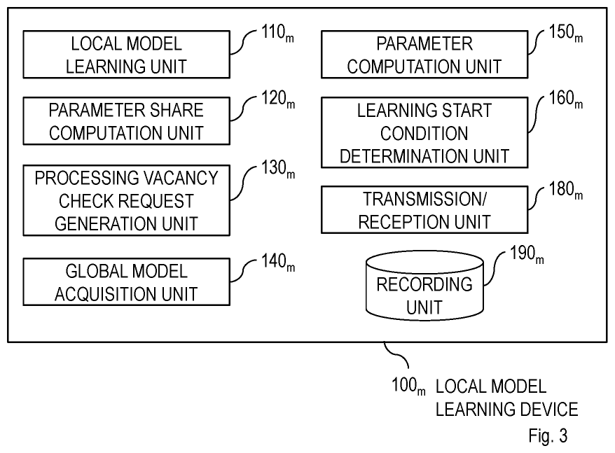

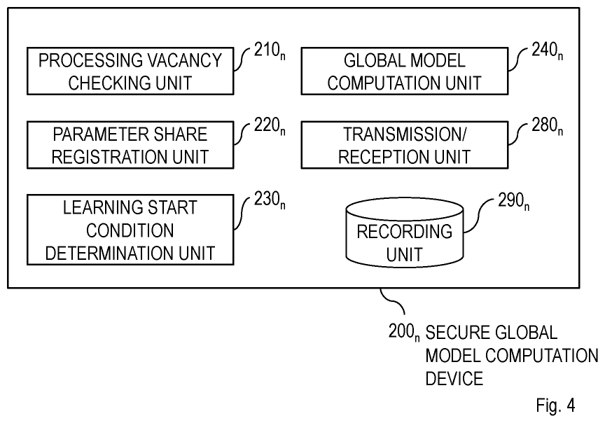

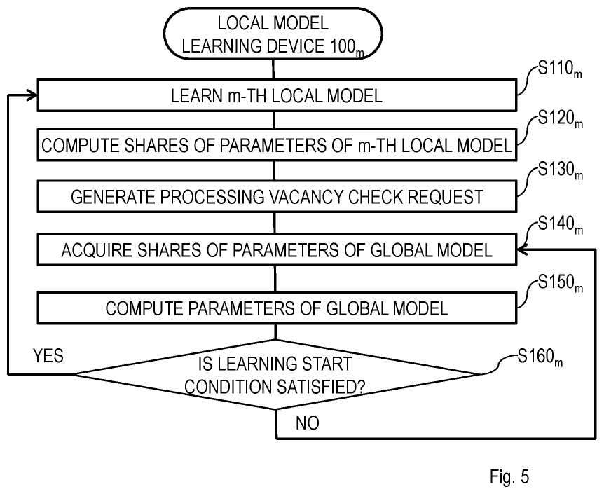

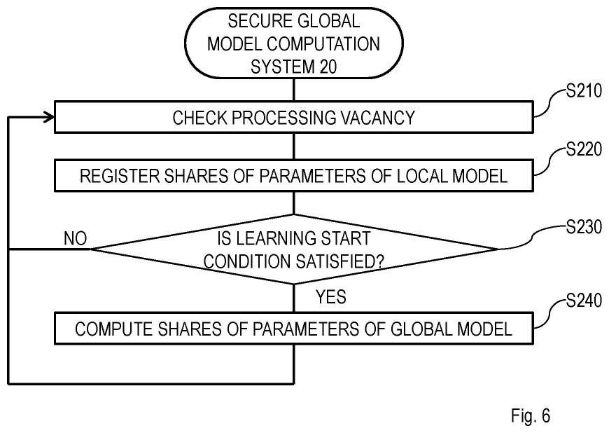

Hereinafter, a federated learning system 10 will be described with reference to FIGS. 2 to 6. FIG. 2 is a block diagram showing a configuration of the federated learning system 10. The federated learning system 10 includes M (M is an integer of 2 or more) local model learning devices 100₁, . . . , 100_{M} and a secure global model computation system 20. The secure global model computation system 20 includes N (N is an integer of 3 or more) secure global model computation devices 200₁, . . . , 200_{N}. The local model learning devices 100₁, . . . , 100_{M} are connected to a network 800 and can communicate with the secure global model computation system 20. The secure global model computation devices 200₁, . . . , 200_{N} are connected to the network 800 and can communicate with each other. The network 800 may be, for example, a communication network such as the Internet or a broadcast communication path. FIG. 3 is a block diagram showing a configuration of a local model learning device 100ₘ (1≤m≤M). FIG. 4 is a block diagram showing a configuration of a secure global model computation device 200ₙ (1≤n≤N). FIG. 5 is a flowchart showing an operation of the local model learning device 100ₘ. FIG. 6 is a flowchart showing an operation of the secure global model computation system 20.

As shown in FIG. 3, the local model learning device 100ₘ includes a local model learning unit 110ₘ, a parameter share computation unit 120ₘ, a processing vacancy check request generation unit 130ₘ, a global model acquisition unit 140ₘ, a parameter computation unit 150ₘ, a learning start condition determination unit 160ₘ, a transmission/reception unit 180ₘ, and a recording unit 190ₘ. The recording unit 190ₘ is a component that record information necessary for processing of the local model learning device 100ₘ. For example, the recording unit 190ₘ records training data and parameters of a local model. Note that training data is updated as appropriate.

As shown in FIG. 4, the secure global model computation device 200ₙ includes a processing vacancy checking unit 210ₙ, a parameter share registration unit 220ₙ, a learning start condition determination unit 230ₙ, a global model computation unit 240ₙ, a transmission/reception unit 280ₙ, and a recording unit 290ₙ. Each component of the secure global model computation device 200ₙ excluding the processing vacancy checking unit 210ₙ, the parameter share registration unit 220ₙ, the transmission/reception unit 280ₙ, and the recording unit 290ₙ is configured to be able to execute an arithmetic operation necessary to realize the function of each component among arithmetic operations necessary for computation of a global model, such as concealment, addition, subtraction, multiplication, division, logical operations, and comparison operations, for example. A specific functional configuration for realizing individual arithmetic operations in the present invention is sufficient to be a configuration capable of executing existing algorithms, and since these are conventional configurations, detailed description thereof will be omitted. Further, the recording unit 290ₙ is a component that records information necessary for processing of the secure global model computation device 200ₙ. The recording unit 290ₙ records, for example, the shares of parameters of a local model and shares of parameters of a global model. Note that the secure global model computation device 200ₙ differs from the local model learning device 100ₘ in that training data is not recorded therein. Further, a global model is a model having the same structure as a local model.

The secure global model computation system 20 realizes secure computation of a global model that is a multiparty protocol according to cooperative computation by N secure global model computation devices 200ₙ. Therefore, a learning start condition determination means 230 (not shown) of the secure global model computation system 20 includes learning start condition determination units 230₁, . . . , 230_{N}, and a global model computation means 240 (not shown) includes global model computation units 240₁, . . . , 240_{N}.

Hereinafter, the operation of the local model learning device 100ₘ will be described with reference to FIG. 5. The local model learning device 100ₘ is called an m-th local model learning device 100, and a local model learned by the local model learning device 100ₘ is called an m-th local model. That is, the m-th local model learning device 100 learns the m-th local model using training data.

In S110ₘ, the local model learning unit 110ₘ learns the m-th local model using training data recorded in the recording unit 190ₘ. In the first learning of the m-th local model, the local model learning unit 110ₘ may set initial values of parameters of the m-th local model using initial values recorded in advance in the recording unit 190ₘ or may set initial values of parameters of the m-th local model using initial values generated using random numbers. In the second and subsequent learning of the m-th local model, the local model learning unit 110ₘ sets initial values of parameters of the m-th local model using a global model acquired in S140ₘ which will be described later.

In S120ₘ, the parameter share computation unit 120ₘ computes the shares of the parameters of the m-th local model from the parameters of the m-th local model learned in S110ₘ.

In S130ₘ, the processing vacancy check request generation unit 130ₘ generates a processing vacancy check request when the computation of S120ₘ is finished. The processing vacancy check request generation unit 130ₘ transmits the processing vacancy check request to the secure global model computation devices 200₁, . . . , 200_{N} using the transmission/reception unit 180ₘ when the generation is finished. In a case in which the processing vacancy check request generation unit 130ₘ has received a local model transmission instruction from the secure global model computation devices 200₁, . . . , 200_{N} using the transmission/reception unit 180ₘ, the processing vacancy check request generation unit 130ₘ transmits the shares of the parameters of the m-th local model to the secure global model computation devices 200₁, . . . , 200_{N} using the transmission/reception unit 180ₘ, and in other cases, re-transmits the processing vacancy check request to the secure global model computation devices 200₁, . . . 200_{N} using the transmission/reception unit 180ₘ after the elapse of a predetermined time.

In S140ₘ, the global model acquisition unit 140ₘ acquires the shares of the parameters of the global model from the secure global model computation devices 200₁, . . . , 200_{N} using the transmission/reception unit 180ₘ after the end of processing of S130ₘ or after the elapse of a predetermined time from the end of processing of S160ₘ.

In S150m, the parameter computation unit 150m computes parameters of the global model from the shares of the parameters of the global model acquired in S140m. The parameter computation unit 150m records the computed parameters of the global model in the recording unit 190m. Note that, in the recording unit 190m, at least two sets of the parameters of the global model, that is, the parameters of the global model obtained through the current computation and the parameters of the global model obtained through the previous computation are recorded.

In S160ₘ, the learning start condition determination unit 160ₘ compares the parameters of the global model computed in S150ₘ with the parameters of the global model obtained in the previous computation, executes processing of S110ₘ upon determining that a learning start condition is satisfied in a case in which the two sets of the parameters of the global model are different, and returns to processing of S140ₘ upon determining that the learning start condition is not satisfied in other cases.

Hereinafter, the operation of the secure global model computation system 20 will be described with reference to FIG. 6. Here, the secure global model computation system 20 performs secure computation of a global model from M local models.

In S210, the processing vacancy checking unit 210ₙ of the secure global model computation device 200ₙ (1≤n≤N) checks whether or not the secure global model computation devices 200₁, . . . , 200_{N} have processing vacancy upon receiving a processing vacancy check request transmitted by one of the local model learning devices 100₁, . . . , 100_{M} using the transmission/reception unit 280ₙ, transmits a local model transmission instruction to the local model learning device which has transmitted the processing vacancy check request and enters a reception waiting state in a case in which all of the secure global model computation devices 200₁, . . . , 200_{N} have processing vacancy, and transmits information indicating that a local model cannot be transmitted to the local model learning device in other cases. In such a case, the secure global model computation devices 200₁, . . . , 200_{N} checks whether or not all of the secure global model computation devices 200₁, . . . , 200_{N} have processing vacancy using a consensus algorithm and determines whether or not all the secure global model computation devices 200₁, . . . , 200_{N} are in a reception waiting state. For example, RAFT or Paxos can be used as the consensus algorithm.

In S220, the parameter share registration unit 220ₙ of the secure global model computation device 200ₙ (1≤n≤N) takes the shares of the parameters of the local model learned by the local model learning device which has transmitted the processing vacancy check request received using the transmission/reception unit 280ₙ as inputs and registers the shares of the parameters of the local model in a local model management table. Here, the local model management table is a table for managing shares of parameters of M local models and is recorded in the recording unit 290ₙ.

In S230, the learning start condition determination means 230 executes processing of S240 upon determining that a learning start condition is satisfied in a case in which the number of newly registered local models exceeds a predetermined value (this value is 1 or more and M or less), or is equal to or greater than the predetermined value after the previous global model is computed, and returns to processing of S210 upon determining that the learning start condition is not satisfied in other cases.

In S240, the global model computation means 240 calculates shares of parameters of the global model using the shares of the parameters of the local models managed by the local model management table. The global model computation means 240 sets, for example, the average of shares of corresponding parameters from the first local model to the M-th local model as the shares of the parameters of the global model.

According to an embodiment of the present invention, it is possible to efficiently receive a local model required to compute a global model in federated learning.

### Second Embodiment

Although the local model learning device 100ₘ of the first embodiment determines whether or not to transmit shares of parameters of a local model by transmitting a processing vacancy check request to the secure global model computation devices 200₁, . . . , 200_{N}, a local model learning device of a second embodiment determines whether or not to transmit shares of parameters of a local model by transmitting a processing vacancy check request to one predetermined secure global model computation device among the secure global model computation devices 200₁, . . . , 200_{N}. Hereinafter, one predetermined secure global model computation device among the secure global model computation devices 200₁, . . . , 200_{N} is referred to as a master secure global model computation device. In the following, for the sake of simplicity, the secure global model computation device 200₁ will be described as a master secure global model computation device.

Hereinafter, differences between the first embodiment and the second embodiment will be described. Specifically, the operation of the processing vacancy check request generation unit 130ₘ of the local model learning device 100ₘ and the operation of the processing vacancy checking unit 210ₙ of the secure global model computation device 200ₙ will be described.

First, the operation of the processing vacancy check request generation unit 130ₘ of the local model learning device 100ₘ will be described.

In S130ₘ, the processing vacancy check request generation unit 130ₘ generates a processing vacancy check request when the computation of S120ₘ is finished. When the generation is finished, the processing vacancy check request generation unit 130ₘ transmits a processing vacancy check request to the secure global model computation device 200₁ serving as a master secure global model computation device using the transmission/reception unit 180ₘ. In a case in which the processing vacancy check request generation unit 130ₘ obtains information indicating that N secure global model computation devices are in a local model reception waiting state from the secure global model computation device 200₁ using the transmission/reception unit 180ₘ, the processing vacancy check request generation unit 130ₘ transmits the shares of parameters of the m-th local model to the secure global model computation devices 200₁, . . . , 200_{N} using the transmission/reception unit 180ₘ, and in other cases, re-transmits the processing vacancy check request to the secure global model computation device 200₁ using the transmission/reception unit 180ₘ after the elapse of a predetermined time.

Next, the operation of the processing vacancy checking unit 210ₙ of the secure global model computation device 200ₙ will be described.

In S210, the processing vacancy checking unit 210₁ of the secure global model computation device 200₁ serving as a master secure global model computation device checks whether or not N-1 secure global model computation devices excluding the secure global model computation device 200₁ have processing vacancy at any time using the transmission/reception unit 280₁, discloses the fact that N secure global model computation devices are in a local model reception waiting state in a case in which all of the N secure global model computation devices have processing vacancy, discloses the fact that they are not in the local model reception waiting state in other cases. Further, the processing vacancy checking unit 210ₙ of the secure global model computation device 200ₙ (2≤n≤N) replies whether the secure global model computation device 200ₙ itself has processing vacancy to check presence or absence of processing vacancy at any time from the secure global model computation device 200₁ using the transmission/reception unit 280ₙ.

According to an embodiment of the present invention, it is possible to efficiently receive a local model required to compute a global model in federated learning.

### Additional Note

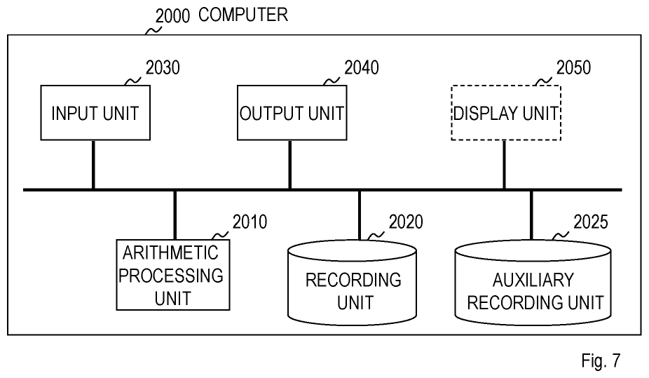

Processing of each unit of each device described above may be realized by a computer, and in this case, processing details of functions that each device should have are described by a program. Then, various types of processing functions in each device described above are realized on a computer 2000 by causing this program to be read by a recording unit 2020 of the computer 2000 shown in FIG. 7 and operating an arithmetic processing unit 2010, an input unit 2030, an output unit 2040, an auxiliary recording unit 2025, and the like.

The device of the present invention includes, for example, as a single hardware entity, an input unit that can receive a signal from the outside of the hardware entity, an output unit that can output a signal to the outside of the hardware entity, a communication unit to which a communication device (for example, a communication cable) capable of communicating with the outside of the hardware entity can be connected, a CPU (Central Processing Unit: which may include a cache memory, a register, and the like) that is an arithmetic processing unit, a RAM and a ROM which are memories, an external storage device that is a hard disk, and a bus which connects the input unit, output unit, communication unit, CPU, RAM, ROM, and external storage device such that data can be exchanged therebetween. Further, if necessary, the hardware entity may be provided with a device (drive) or the like capable of reading and writing data from/to a recording medium such as a CD-ROM. A physical entity including such hardware resources includes a general-purpose computer.

The external storage device of the hardware entity stores programs necessary for realizing the functions described above, data necessary for processing the programs, and the like (not limited to the external storage device, for example, the program may be stored in a ROM which is a read-only storage device). In addition, data and the like obtained by processing these programs are appropriately stored in a RAM, an external storage device, or the like.

In the hardware entity, each program stored in the external storage device (or a ROM or the like) and data necessary for processing of each program are read into a memory as necessary and appropriately interpreted, executed, or processed by a CPU. As a result, the CPU realizes predetermined functions (the components described above as units, means, etc.). In other words, each of the components of the embodiments of the present invention may be constituted by processing circuitry.

As described above, when the processing function in the hardware entity (the device according to the present invention) described in the above-described embodiments is implemented by the computer, details of processing of the function included in the hardware entity is written by the program. Then, by executing this program on the computer, the processing function in the above-described hardware entity is implemented on the computer.

The program in which the details of this processing is written can be recorded on a computer-readable recording medium. The computer-readable recording medium is, for example, a non-transitory recording medium, and specifically a magnetic recording device, an optical disc, or the like.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

The computer executing such a program first temporarily stores the program recorded in the portable recording medium or the program transferred from the server computer, for example, in the auxiliary recording unit 2025, which is its own non-transitory storage device. Then, when executing processing, the computer reads the program stored in the auxiliary recording unit 2025 serving as its own non-transitory storage device onto the recording unit 2020, and executes processing according to the read program. Alternatively, as another form of executing the program, the computer may read the program directly from the portable recording medium onto the recording unit 2020, and execute processing according to the program, or the computer may sequentially execute processing according to the program received from a server computer every time the program is transferred thereto from the server computer. Furthermore, instead of transferring the program to the computer from a server computer, the processing described above may be executed by a so-called ASP (Application Service Provider) type service, in which a processing function is realized by execution commands and result acquisition alone. Note that the program according to the present embodiment includes information to be used for processing by an electronic computer and equivalent to the program (data which is not a direct command to the computer but has a property that regulates the processing of the computer and the like).

In addition, although the present device is configured by executing a predetermined program on the computer in this form, at least a part of the details of processing may be realized by hardware.

The present invention is not limited to the above-described embodiment, and appropriate changes can be made without departing from the spirit of the present invention.

1. A secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device comprising:
a processing vacancy checking circuitry configured to check whether or not the N secure global model computation devices have processing vacancy when a processing vacancy check request transmitted by one of the M local model learning devices is received and to transmit a local model transmission instruction to the local model learning device and enter a reception waiting state when all of the N secure global model computation devices have processing vacancy;
a transmission/reception circuitry configured to receive shares of parameters of a local model learned by the local model learning device; and
a parameter share registration circuitry configured to register the shares of the parameters of the local model.

2. A local model registration method comprising:
a processing vacancy checking step in which a secure global model computation device in a federated learning system including M local model learning devices for learning local models using training data and a secure global model computation system composed of N secure global model computation devices for performing secure computation of a global model from M local models checks whether or not the N secure global model computation devices have processing vacancy when a processing vacancy check request transmitted by one of the M local model learning devices is received, and transmits a local model transmission instruction to the local model learning device and enters a reception waiting state when all of the N secure global model computation devices have processing vacancy, wherein M is an integer of 2 or more and N is an integer of 3 or more;
a transmission/reception step in which the secure global model computation device receives shares of parameters of a local model learned by the local model learning device; and
a parameter share registration step in which the secure global model computation device registers the shares of the parameters of the local model.

3. A secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device comprising:
a processing vacancy checking circuitry configured to check whether or not N-1 secure global model computation devices excluding the secure global model computation device itself have processing vacancy at any time and to disclose the fact that the N secure global model computation devices are in a local model reception waiting state when all of the N secure global model computation devices have processing vacancy;
a transmission/reception circuitry configured to receive shares of parameters of a local model learned by one of the M local model learning devices; and
a parameter share registration circuitry configured to register the shares of the parameters of the local model.

4. A secure global model computation device in a federated learning system including M local model learning devices for learning local models using training data and a secure global model computation system composed of N secure global model computation devices for performing secure computation of a global model from M local models, wherein M is an integer of 2 or more and N is an integer of 3 or more, the secure global model computation device comprising:
wherein a secure global model computation device different from the secure global model computation device itself, which discloses the fact the N secure global model computation devices are in a local model reception waiting state when all of the N secure global model computation devices have processing vacancy, is set as a master secure global model computation device,
a processing vacancy checking circuitry configured to reply whether the secure global model computation device itself has processing vacancy to check presence or absence of processing vacancy at any time from the master secure global model computation device;
a transmission/reception circuitry configured to receive shares of parameters of a local model learned by one of the M local model learning devices; and
a parameter share registration circuitry configured to register the shares of the parameters of the local model.

5. A local model registration method comprising:
a processing vacancy checking step in which a secure global model computation device in a federated learning system including M local model learning devices for learning local models using training data and a secure global model computation system composed of N secure global model computation devices for performing secure computation of a global model from M local models checks whether or not N-1 secure global model computation devices excluding the secure global model computation device itself have processing vacancy at any time, and discloses the fact that the N secure global model computation devices are in a local model reception waiting state when all of the N secure global model computation devices including the secure global model computation device itself have processing vacancy, wherein M is an integer of 2 or more and N is an integer of 3 or more;
a transmission/reception step in which the secure global model computation device receives shares of parameters of a local model learned by one of the M local model learning devices; and
a parameter share registration step in which the secure global model computation device registers the shares of the parameters of the local model.

6. A local model registration method comprising:
a processing vacancy checking step in which a secure global model computation device in a federated learning system including M local model learning devices for learning local models using training data and a secure global model computation system composed of N secure global model computation devices for performing secure computation of a global model from M local models replies whether the secure global model computation device itself has processing vacancy to check presence or absence of processing vacancy at any time from a secure global model computation device different from the secure global model computation device itself, which discloses the fact the N secure global model computation devices are in a local model reception waiting state when all of the N secure global model computation devices have processing vacancy, wherein M is an integer of 2 or more and Nis an integer of 3 or more;
a transmission/reception step in which the secure global model computation device receives shares of parameters of a local model learned by one of the M local model learning devices; and
a parameter share registration step in which the secure global model computation device registers the shares of the parameters of the local model.

7. A non-transitory computer-readable storage medium which stores a program for causing a computer to function as the secure global model computation device according to claim 1.

8. A non-transitory computer-readable storage medium which stores a program for causing a computer to function as the secure global model computation device according to claim 3.

9. A non-transitory computer-readable storage medium which stores a program for causing a computer to function as the secure global model computation device according to claim 4.
